(19) United States
(12) Patent Application Publication
(10) Pub. No.: US 2012/0185087 A1
(43) Pub. Date: Jul. 19, 2012

(54) TWO-WHEEL TYPE THROWING ROBOT

(75) Inventor: Jeong Ho Kang, Daegu (KR)

(73) Assignee: HOYAROBOT CO., LTD, Daegu (KR)

(21) Appl. No.: 13/388,035

(22) PCT Filed: Sep. 17, 2010
(86) PCT No.: PCT/KR2010/006383

§ 371 Date: Jan. 30, 2012

(30) Foreign Application Priority Data
Sep. 30, 2009 (KR) 20-2009-0012858

(51) Int. Cl. G06F 19/00

(52) U.S. Cl. 700/245; 901/1

(57) ABSTRACT

The present invention relates to a two-wheel type robot provided with two driving wheels. Supporting legs that closely contact or separate from a body have sharp ends, wherein the sharp ends are formed with curved surfaces for minimizing frictional forces. A cover for securing a battery mounting space is integrally formed in the supporting legs for a supporting leg to pass a raised protrusion smoothly and not be caught on the raised protrusion in the process of passing the raised protrusion, thereby enabling the two-wheel type throwing robot to move stably.

### CROSS-REFERENCE TO RELATED APPLICATIONS

The present application claims priority to Korean Patent Application 20-2009-0012858 (filed on Sep. 30, 2009) and PCT Patent Application No. PCT/KR2010/006383 (filed on Sep. 17, 2010), both of which are hereby incorporated by reference in its entirety.

### TECHNICAL FIELD

The present disclosure relates to a throwing robot including two driving wheels, and more particularly, to a throwing robot including a supporting leg to maintain a balance of the robot while the robot is in motion.

### BACKGROUND ART

Recently, robots are in use in various fields for different purposes, including industrial, medical and disaster prevention, as control technology advances. In many cases, such robots move with a joint and a leg, or a wheel, or both.

The wheel-using examples include the robots moving forward or backward using a gyro sensor or an angular velocity sensor with the body being inverted and a wheel being mounted at the body, as is disclosed in Japan Patent Publication No. 2007-223399, Japan Patent Publication No. 2007-280408, Japan Patent Publication No. 2006-136962, Korea Patent Publication No. 10-2005-0079122, Korea Patent Publication No. 10-2007-0099146, Japan Patent Publication No. 2005-0288587, Japan Patent Publication No. 2004-0345030, etc.

The inverted robots disclosed in Japan Patent Publication No. 2007-223399, Japan Patent Publication No. 2007-280408 and Japan Patent Publication No. 2006-136962 are two-wheeled robots, which have to circumvent the obstacle when an obstacle such as a stepped protrusion appears while the robots are in motion.

Disclosed in Korea Patent Publication No. 10-2005-0079122 and Korea Patent Publication No. 10-2007-0099146 are robots including not only a plurality of driving wheels at a lower portion of the body but also a fixed auxiliary wheel integrated with the body to deal with the limitation and help the robot maintain a balance. To the same end, a robot mounted with not only a main wheel but also a plurality of auxiliary wheels, which move upward or downward hydraulically in proportion to the height of a stepped protrusion, is disclosed in Japan Patent 2005-0288587, and a robot whose auxiliary wheels move upward or downward in a linked manner is disclosed in Japan Patent Publication No. 2004-0345030.

However, in the case of the robots having a fixed auxiliary wheel, the auxiliary wheel may be caught by the obstacle to block the robot from moving forward as the body of the robot tilts backwards after the driving wheel passes. In the case of the robots having auxiliary wheels moving upward and downward, the auxiliary wheel is mounted separately at an outer surface of the body without exception to increase the volume of the robot. In this case, the robot may pass the stepped protrusion on the ground surface, but is rather vulnerable to a side obstacle. Also, since the auxiliary wheel is always projecting and exposed outside, the auxiliary wheel is prone to damage when the robot is thrown, and thus the robot is not suitable for throwing use in a fire scene and the like.

The robot disclosed in Korea Patent 10-0783624, which has a body equal to or smaller than a wheel in size, includes a pair of motors installed at the body, and a pair of wheels are disposed at a motor shaft. The body is equipped with a camera module and types of sensors so that information obtained by the sensor and camera modules are transmitted outside wirelessly through a transmission system. In an emergency case such as an act of terrorism or fire, the robot can absorb impacts caused by collision while being thrown into the danger zone, as though a ball absorbs an impact.

However, since the abovementioned two-wheeled rescue robot has no auxiliary wheel, a fine control is required for the robot to maintain a balance while in motion. Besides, the robot may not be able to proceed when a stepped protrusion appears, and, if the robot manages to proceed, it may take much time for the body to have a regular, i.e., inverted, position after the robot proceeds.

In previously filed Patent Application 10-2009-0008625 of the inventor of the present invention, a two-wheeled robot including two driving wheels 20, which are driven by a driving motor as illustrated in FIG. 1, at both sides of the body is disclosed. The robot includes electric devices which include a camera module and types of sensors (temperature sensor, gas sensor, gyro sensor, etc.). The robot of the said application includes an auxiliary wheel which includes a supporting leg 110 having an arc shape and not projecting outside the driving wheel 20 when coming into tight contact with the body, and end of which is disposed in a rotatable manner at the body, an auxiliary motor 120 disposed at the supporting leg 110 or the body to be connected with the supporting leg 110 directly or via a power transmission medium and rotate the supporting leg 110, a ball caster 130 disposed at the end of the supporting leg 110, and an elastic buffer plate 140 projecting toward the body from a joint between the ball caster 130 and the supporting leg 110.

In the buffer plate 140, an end part (hereinafter referred to as the projecting part 142) toward outside the body is more projecting than the supporting leg 110, and a part (hereinafter referred to as the elastic part 144) toward the body is bent at a location close to the ball caster 130 to be positioned toward the supporting leg 110 while having elasticity. The buffer plate 140 prevents the supporting leg 110 from being caught by a stepped protrusion 200 for the two-wheeled robot to pass the stepped protrusion 200 well, and protects a main battery disposed at the supporting leg 110 from external impacts.

However, for the two-wheeled throwing robot which includes the buffer plate 140 having a plate shape, an inner end portion of the elastic part is caught in some cases by an obstacle to hamper robot movements.

In addition, since the extra ball caster 130 is mounted at the supporting leg 110, the ball caster 130 may be damaged and fail to position the throwing robot with accuracy while the robot is thrown, and robot movements may be hampered by friction with the ground surface.

### DISCLOSURE OF THE INVENTION

### Technical Problem

Embodiments provide a two-wheeled throwing robot capable of moving with stability by having a pointed end of a supporting leg which comes into tight contact with or is separated from a body, the pointed end having a curved surface to minimize friction, and having an integrated cover defining a battery installation space at the supporting leg so that the supporting leg is prevented from being caught by a stepped protrusion and the robot passes the stepped protrusion well.

### Technical Solution

A two-wheeled throwing robot, wherein two driving wheels driven by a driving motor are disposed at both sides of a body, and an arc-shaped supporting leg is disposed rotatably by an auxiliary motor at a side of the body to prevent the driving wheels from protruding to the outside when coming into contact with the body and to support the body when being unfolded includes: a friction part protruding in a pointed shape at an end of the supporting leg, the pointed end being curved to minimize friction; a reference part protruding outwards in a triangular shape at the end of the supporting leg to function as a balancing reference point by being more protruding outwards than the driving wheels (20) when the supporting leg is put tightly into the body; and a cover which covers a surface of the supporting leg (110) facing the body, and defines a nearly straight surface from the friction part by being more protruding toward the body than the arc-shaped supporting leg.

A main battery may be disposed at a space between the cover and supporting leg.

The friction part, the reference part, and the cover may be integrated with each other.

### Advantageous Effects

According to the embodiment, when the two-wheeled robot is thrown, the supporting leg comes into tight contact with the body, almost no exposure is made outside the driving wheel, and the devices are protected. When the supporting leg is unfolded for movement, three-wheeled driving is made in actuality to stabilize the movement. When the robot passes the stepped protrusion, the driving wheel passes the stepped protrusion first, and then the supporting leg follows, during which the buffer plate is caught by the stepped protrusion so that the supporting leg passes the stepped protrusion smoothly adding to mobility of the robot.

Also, the two-wheeled robot may maintain the inverted position while in motion because the main battery disposed at the supporting leg of the embodiment balances a center of gravity.

### BRIEF DESCRIPTION OF THE DRAWINGS

FIG. 1 is a perspective view of a supporting leg of a two-wheeled throwing robot according to related art.

FIG. 2 is a perspective view of a two-wheeled throwing robot according to an embodiment.

FIG. 3 is a partially cut-away plan view of FIG. 2 illustrating a state in which a supporting leg and a body are coupled with each other.

FIG. 4 is a bottom perspective view of the supporting leg.

FIG. 5 is a side view illustrating a state in which the supporting leg is folded.

FIG. 6 is a side view illustrating a process in which the two-wheeled throwing robot according to the embodiment passes an obstacle.

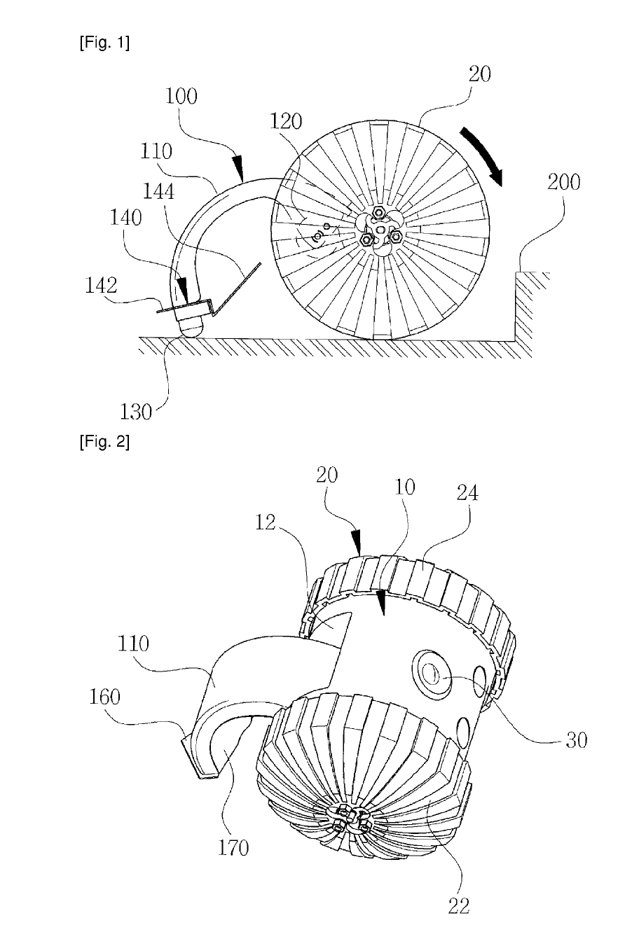

BRIEF DESCRIPTION OF SYMBOLS IN THE DRAWINGS

| | |
|---|---|
| 10: BODY | 20: DRIVING WHEEL |
| 40: MAIN BATTERY | 110: SUPPORTING LEG |
| 120: AUXILIARY MOTOR | 150: FRICTION PART |
| 160: REFERENCE PART | 170: COVER |
| 200: OBSTACLE | |

### MODE FOR CARRYING OUT THE INVENTION

Reference will now be made in detail to the embodiments of the present disclosure, examples of which are illustrated in the accompanying drawings.

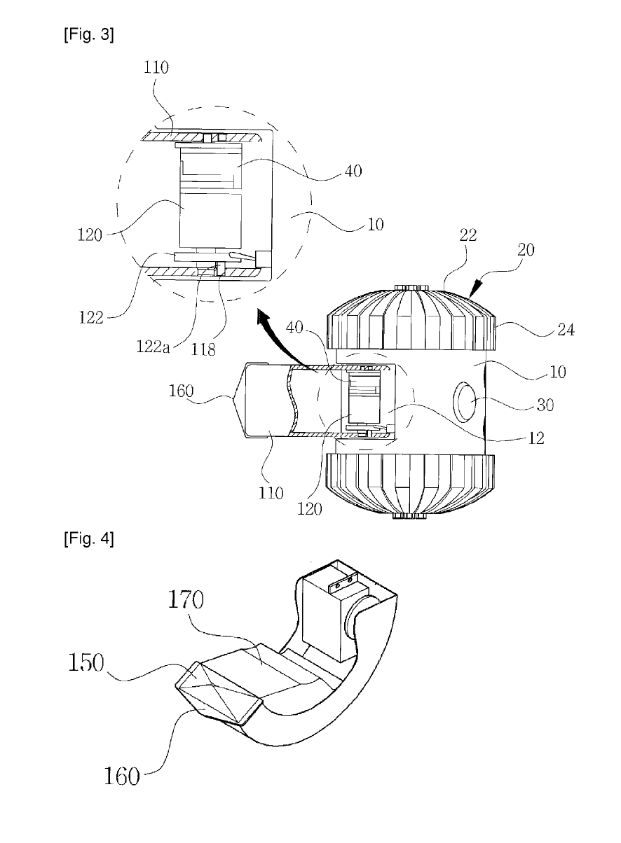

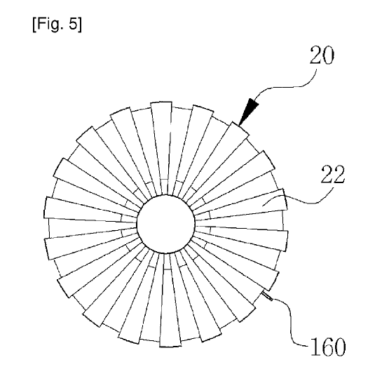

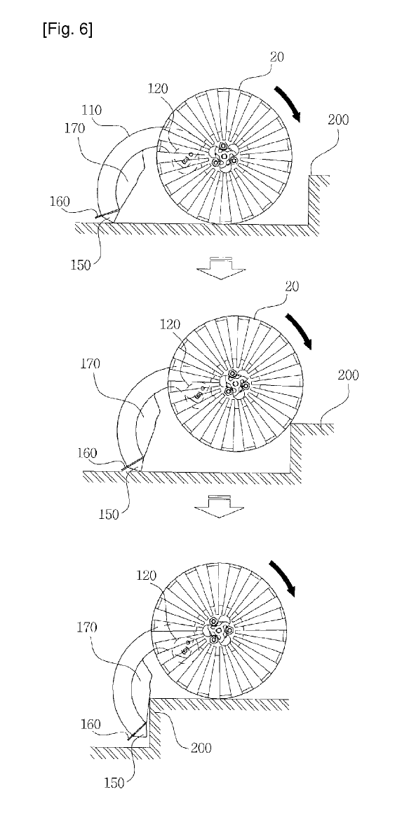

FIG. 2 is a perspective view of a two-wheeled throwing robot according to an embodiment, FIG. 3 is a partially cut-away plan view of FIG. 2 illustrating a state in which a supporting leg and a body are coupled with each other, FIG. 4 is a bottom perspective view of the supporting leg, FIG. 5 is a side view illustrating a state in which the supporting leg is folded, and FIG. 6 is a side view illustrating a process in which the two-wheeled throwing robot according to the embodiment passes an obstacle.

A two-wheeled robot with a supporting leg of the current embodiment includes a body 10, a pair of driving wheels 20 disposed at both side ends of the body 10, a driving motor (not illustrated) driving the driving wheels 20, electric devices including a camera module 30 and sensors (temperature sensor, gas sensor, gyro sensor, etc.) disposed at the body 10, a control unit (not illustrated) controlling driving of the robot by controlling operation of the electric devices, and a supporting leg 110 disposed in a foldable manner at the body 10.

A central axis of the body 10, which has a cylindrical shape, is in parallel with a ground surface, and an insertion groove 12, into which the supporting leg 110 is inserted, is disposed at a side. The camera module 30, the sensor, the control unit, the driving motor and so forth are disposed inside.

The driving wheel 20 has a bowl shape with a ground contact part 24 projecting vertically along a circumferential edge of a convex dish-shaped part 22, and is connected to the (one or two) driving motor directly or via a power transmission medium (chain, belt, etc.) with the dish-shaped part 22 facing the other dish-shaped part 22 symmetrically and the ground contact parts 24 being positioned at outer circumferences of the body 10. The ground contact part 24 coming into contact with the ground surface has a concavo-convex shape so that sliding on the ground surface is prevented during rotation, an impact from falling and the like is absorbed, and strength is enhanced.

The supporting leg 110 of the two-wheeled robot has an arc shape, and is inserted into the insertion groove 12 not to project outside the driving wheel 20 when coming into tight contact with the body 10 while an end is installed rotatably against the body 10, with a hinge shaft, a bearing, or a ball, at the insertion groove 12 of the body 10. The supporting leg 110 is connected for rotation to an auxiliary motor 120 directly or via a power transmission medium.

A pointed friction part 150 protrudes from the end of the supporting leg 110. The pointed end of the friction part 150 is curved to minimize friction with the ground surface. When the supporting leg 110 is unfolded, the friction part 150 comes into contact with the ground surface.

A reference part 160 having a triangular plate shape protrudes outside from where the supporting leg 110 and the friction part 150 form a boundary with each other. The reference part 160 protrudes outwards from the driving wheel and functions as a balancing reference point when the supporting leg 110 is put into an inner portion of the body 10.

Disposed at a surface of the supporting leg 110 facing the body 10 is a cover 170 more protruding toward the body 10 than the arc-shaped supporting leg 110 does and defining a surface nearly straight from the friction part 150. When the two-wheeled robot passes a stepped protrusion, the cover 170 prevents the supporting leg 110 from being caught to hamper the movement. Further disposed at a space defined by the cover 170 between the supporting leg 110 and the cover 170 is a main battery 40 controlling overall movements of the two-wheeled robot. Of all composition of the two-wheeled robot, the main battery 40 is the heaviest in weight. The supporting leg 110 balances an overall center of gravity for the two-wheeled robot while the cover 170 protects the main battery 40.

The auxiliary motor 120 is integrated with the body 10, and a motor shaft is connected to a side of the supporting leg 110 directly or via a power transmission medium such as a gear to rotate the supporting leg 110. In the current embodiment, a rotation center part 114 of the supporting leg 110 and a turning plate 122 is disposed at a shaft of the auxiliary motor 120, and the turning plate 122 and the supporting leg 110 are further coupled with a position spaced from the shaft of the auxiliary motor 120 to forestall sliding rotation. The coupling between the turning plate 122 and the supporting leg 110 is made by making a projection 122a corresponding to a coupling hole 118.

A light is further disposed at the robot.

With the two-wheeled robot of the current embodiment, information obtained by the sensor and camera modules are transmitted outside wirelessly through a transmission system. In an emergency case, the robot is thrown into the danger zone. When the supporting leg 110 is unfolded while the robot moves, the friction part 150 comes into contact with the ground surface, the same effect as moving on three wheels is created, the main battery 40 and the auxiliary motor 120 disposed at the supporting leg 110 have high load, and the robot is allowed to maintain a balance and stability while in motion.

When the supporting leg 110 is unfolded, the robot may be overturned depending on a position of the folded supporting leg 110 (upward, downward). For example, when the supporting leg 110 is positioned upward and the supporting leg 110 is unfolded, the robot turns to have a regular position and makes the friction part 150 touch the ground surface. Then, an outer circumferential surface of an arc shape of the supporting leg 110 comes into contact with the ground surface to overturn the robot (upside down).

In this case of overturn, the reference part 160 touches the a floor, position the robot, and make the robot have a normal position on condition that the robot turns or moves forward to have the normal position while unfolding the supporting leg 110.

When the cover 170 is not installed and a stepped obstacle 200 appears while the robot is in motion with the supporting leg 110 being unfolded, the driving wheel 20 of the robot moves onto the obstacle 200 for moving forward, but the arc-shaped supporting leg 110 is caught by the obstacle 200 and the robot does not move.

When the cover 170 protruding toward the body 10 is installed to pass the step, the supporting leg 110 functions as a prop while the driving wheel 20 passes the obstacle 200 as illustrated in FIG. 6. The driving wheel 20 may overcome the obstacle, and then a projecting surface of the cover 170 touches a corner of the obstacle before the supporting leg 110 passes the obstacle, the supporting leg 110 of the robot is lifted, the robot tilts as a whole, and the supporting leg 110 may pass the obstacle in a sliding manner.

As mentioned earlier, the main battery 40 of the robot is installed at the space between the supporting leg 110 and the cover 170. The main battery 40 functions as the center of gravity of the robot. When an impact is applied to the robot or when there is no buffer plate 140 while the robot overcoming the step or the obstacle, the main battery may be directly damaged. When the robot is used for a disaster prevention purpose, the supporting leg 110 and the cover 170 protect the main battery 40 from an impact caused by the robot colliding with the ground surface after being thrown.

1. A two-wheeled throwing robot, wherein two driving wheels (20) driven by a driving motor are disposed at both sides of a body (10), and an arc-shaped supporting leg (110) is disposed rotatably by an auxiliary motor (120) at a side of the body (10) to prevent the driving wheels (20) from protruding to the outside when coming into contact with the body (10) and to support the body (10) when being unfolded, the two-wheeled throwing robot comprising:
a friction part (150) protruding in a pointed shape at an end of the supporting leg (110), the pointed end being curved to minimize friction;
a reference part (160) protruding outwards in a triangular shape at the end of the supporting leg (110) to function as a balancing reference point by being more protruding outwards than the driving wheels (20) when the supporting leg (110) is put tightly into the body (10); and
a cover (170) which covers a surface of the supporting leg (110) facing the body (10), and defines a nearly straight surface from the friction part (150) by being more protruding toward the body (10) than the arc-shaped supporting leg (110).

2. The two-wheeled throwing robot according to claim 1, wherein a main battery (40) is disposed at a space between the cover (170) and supporting leg (110).

3. The two-wheeled throwing robot according to claim 1, wherein the friction part (150), the reference part (160), and the cover (170) are integrated with each other.
